(19) United States
(12) Patent Application Publication
(10) Pub. No.: US 2026/0028511 A1
(43) Pub. Date: Jan. 29, 2026

(54) BIODEGRADABLE HOT MELT ADHESIVE COMPRISING MALEATED PBAT AND MANUFACTURING METHOD THEREOF

(71) Applicant: Kyungpook National University Industry-Academic Cooperation Foundation, Daegu (KR)

(72) Inventor: Dong Yun LEE, Suwon-si (KR)

(21) Appl. No.: 19/274,114

(22) Filed: Jul. 18, 2025

(30) Foreign Application Priority Data
Jul. 25, 2024 (KR) 10-2024-0098547

(51) Int. Cl. C09J 167/02; C08G 63/91

(52) U.S. Cl. CPC C09J 167/02; C08G 63/916

(57) ABSTRACT

Provided is a biodegradable hot melt adhesive including maleated PBAT, which is prepared by grafting maleic acid onto PBAT using a PBAT resin with excellent biodegradability, maleic acid, and an initiator, and a method of preparing the same. The hot melt adhesive has improved adhesive strength while maintaining biodegradability almost similar to that of PBAT, and therefore may be used as a hot melt adhesive for products requiring biodegradability, such as packaging paper and packaging containers including biodegradable resins.

### CROSS-REFERENCE TO RELATED APPLICATION(S)

This application claims priority to and the benefit of Korean Patent Application No. 10-2024-0098547, filed on Jul. 25, 2024, the disclosure of which is incorporated herein by reference in its entirety.

### STATEMENT REGARDING PRIOR DISCLOSURES BY THE INVENTOR OR A JOINT INVENTOR

Non-patent literatures entitled, “Enhancing Hot-Melt Adhesive Properties in PBAT: A study on Maleic Anhydride Grafting” and “Maleic Anhydride Grafting of Poly(butylene adipate-co-terephthalate) (PBAT) for Eco-friendly Hot-Melt Adhesion”, which were published on Oct. 12, 2023, and Apr. 5, 2024, respectively, are not a prior art under 35 USC 102 as being disclosures made directly or indirectly by the inventor or a joint inventor 1 year or less before the effective filing date of the instant application. Copies of the non-patent literature prior disclosures are being submitted with the instant application in an Information Disclosure Statement pursuant to 37 CFR 1.97 and 1.98.

### BACKGROUND

### 1. Field of the Invention

The present invention relates to an environmentally friendly hot melt adhesive which does not include a solvent, has excellent biodegradability, and possesses excellent adhesion, so that it can be easily applied to various products, and a method of preparing the same. In particular, the present invention relates to a hot melt adhesive prepared by grafting maleic acid onto a polybutylene adipate terephthalate (PBAT) resin which has excellent biodegradability, and a method of preparing the same.

### 2. Discussion of Related Art

Polymer materials are materials that are used for various purposes because they have excellent physical properties despite being relatively inexpensive compared to other materials. Therefore, the production of polymer materials is increasing every year, and most of the polymer materials commonly used are petroleum-derived polymers such as PP, PE, PS, and PMMA.

Because petroleum-derived polymers take a very long time to decompose naturally, the amount of accumulated waste increases to an unmanageable level, which is the main cause of environmental pollution today. Therefore, extensive research is being performed to find solutions to environmental pollution problems caused by these polymer materials. One of them is a method of replacing existing petroleum-derived polymers with biodegradable polymer materials.

Biodegradable plastics can be decomposed into water, carbon dioxide, and biomass by the action of living organisms. Accordingly, social demand to prevent environmental pollution caused by petroleum-derived plastics is increasing, and the biodegradable plastic market is continuing to show strong growth. Among them, packaging and containers account for approximately 61% of the total biodegradable plastic market size.

However, research to replace adhesives used to seal packaging materials with biodegradable materials is not yet actively underway, and in particular, there are not many research and development results on hot melt adhesives (HMAs) with biodegradability.

Hot melt adhesives are one of the environmentally friendly solvent-free adhesives, and because they show adhesion on various substrates, they are used in various fields such as packaging, automobiles, electronic products, and clothing.

However, hot melt adhesives are generally prepared from non-biodegradable polymers such as EVA, polyolefin, and styrene block copolymer, and thus are not meeting the market demand for environmentally friendly products.

### SUMMARY OF THE INVENTION

The present invention is intended to solve the problems described above, and to provide a hot melt adhesive having biodegradability while having the advantages of being able to adhere to various materials without the need for a solvent and being easily applicable, unlike existing hot melt adhesives, and a method of preparing the same.

The present invention provides a biodegradable hot melt adhesive comprising maleated PBAT.

The maleated PBAT may be prepared by heating and mixing a radical initiator and maleic anhydride with a PBAT resin to graft maleic acid onto a molten PBAT chain for a short reaction time.

The maleated PBAT may be grafted with 0.07 to 0.18% maleic acid, preferably 0.12 to 0.16%. When a content of maleic acid grafted to the PBAT is below or exceeds the above range, the adhesion is reduced.

The biodegradable hot melt adhesive comprising maleated PBAT according to the present invention further comprises one or more additives selected from the group consisting of a tackifier, an adhesion regulator, an antioxidant, a plasticizer, a pigment, and a filler, so that the adhesiveness, thermal stability, color, and mechanical strength of the hot melt adhesive may be controlled.

The present invention provides a method of preparing a biodegradable hot melt adhesive comprising maleated PBAT, the method comprising the steps of: mixing a PBAT resin, maleic acid, and an initiator to prepare a mixture; and heating and mixing the mixture to graft maleic acid onto PBAT, wherein the mixture may comprise 1 to 7 parts by weight of maleic acid and 0.1 to 0.7 parts by weight of the initiator, and preferably 5 parts by weight of maleic acid and 0.5 parts by weight of the initiator, based on 100 parts by weight of the PBAT resin.

In the method of preparing a biodegradable hot melt adhesive comprising maleic acid PBAT of the present invention, the step of heating and mixing the mixture to grafting maleic acid onto PBAT may be performed at 185 to 195° C. for 7 to 13 minutes.

### Advantageous Effects

A biodegradable hot melt adhesive comprising maleated PBAT according to the present invention has biodegradability as in PBAT, but has significantly improved adhesion compared to PBAT, and therefore can be used as an adhesive for various products requiring biodegradability, and in particular, can be utilized as an adhesive required for the manufacture of packaging paper and packaging containers using a biodegradable resin as a raw material, and for products using the packaging paper and packaging containers.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows ATR-FTIR spectra for examples and comparative examples according to the present invention. (a) and (b) show spectra before purification, and (c) and (d) show spectra after purification;

FIG. 2 shows the results of measuring dynamic rheological properties, including (a) storage modulus, (b) loss modulus, (c) complex viscosity, and (d) tan 8 vs. angular frequency;

FIG. 3 shows (a) the Van Gurp-Palmen plot and (b) the Cole-Cole plot, as measured at 160° C.

FIG. 4 shows frequency sweep curves and cross-over points measured at 160° C.;

FIG. 5 shows the TGA measurement results;

FIG. 6 shows the results of the adhesion test, where (a) and (c) are graphs showing Lap shear strength, and (b) and (d) are graphs showing Lap shear strength and displacement; and

FIG. 7 shows the results of evaluating the biodegradability of cellulose, PBAT, and maleated PBAT according to Example 3.

### DETAILED DESCRIPTION OF EXEMPLARY EMBODIMENTS

The terminology used herein is for the purpose of describing the embodiments, and is not intended to limit the present invention. In this specification, a singular expression includes a plural expression unless the context clearly indicates otherwise. The word “comprises” as used in the specification does not exclude the presence or addition of one or more other components other than the mentioned components.

Unless otherwise defined, all terms (including technical and scientific terms) used in the present specification may be used in a meaning commonly understood by those of ordinary skill in the art to which the present invention belongs. In addition, terms defined in commonly used dictionaries are not interpreted ideally or excessively unless explicitly specifically defined.

A biodegradable hot melt adhesive comprising maleated PBAT according to the present invention comprises maleated PBAT.

The maleated PBAT may be prepared by grafting maleic anhydride onto a molten PBAT chain for a short reaction time using a radical initiator. As the content of maleic anhydride and initiator added in the reaction process increases, the adhesive strength and melt viscosity of maleated PBAT are improved.

The maleated PBAT may be used in which maleic acid is grafted at 0.07 to 0.18%, preferably 0.12 to 0.16%, and when the content of maleic acid grafted to the PBAT is below or exceeds the above range, the adhesion is reduced.

The biodegradable hot melt adhesive comprising maleated PBAT according to the present invention may further include, in addition to maleated PBAT, one or more additives selected from the group consisting of a tackifier, an adhesion regulator, an antioxidant, a plasticizer, a pigment, and a filler.

By controlling the additives, the adhesiveness, thermal stability, color, and mechanical strength of the hot melt adhesive may be controlled.

The biodegradable hot melt adhesive comprising maleated PBAT according to the present invention may be prepared by a preparation method comprising mixing a PBAT resin, maleic acid, and an initiator to prepare a mixture; and heating and mixing the mixture to graft maleic acid onto PBAT, wherein the mixture may comprise 1 to 7 parts by weight of maleic acid and 0.1 to 0.7 parts by weight of the initiator, and preferably 5 parts by weight of maleic acid and 0.5 parts by weight of the initiator, based on 100 parts by weight of the PBAT resin.

In the method of preparing a biodegradable hot melt adhesive comprising maleic acid PBAT of the present invention, the step of heating and mixing the mixture to grafting maleic acid onto PBAT may be performed at 185 to 195° C. for 7 to 13 minutes.

Hereinafter, the biodegradable hot melt adhesive comprising maleated PBAT, a method of preparing the same, and the adhesion and biodegradability of the biodegradable hot melt adhesive comprising maleated PBAT are described in detail through examples of the present invention so that a person having ordinary skill in the art to which the present invention pertains can easily carry out the invention. However, the present invention may be embodied in many different forms and is not limited to the embodiments set forth herein.

### 1. Preparation of Maleated PBAT Hot Melt Adhesives

Poly(butylene-co-adipate terephthalate) (PBAT, PBAT A400) from Kingfa Sci. & Tech. Co., Ltd. (Guangzhou, China) was dried in a vacuum oven at 50° C. for 12 h.

After drying, PBAT, maleic anhydride (>99.0%, MA) from Sigma-Aldrich, and the initiator (2,5-dimethyl-2,5-di(tert-butylperoxy) hexane, Trigonox®) from Nouryon Co., Ltd. were mixed in the composition ratio as disclosed in Table 1.

The mixture was input to a reactive blender (Brabender® GmbH & Co. KG) and mixed and reacted at 190° C. and 50 rpm for 10 minutes.

After the reaction, the generated reaction product was cooled in a freezer at −20° C. After cooling, the reaction product was placed into a mold and processed at 160° C. and 2 psi through a hot press to form a 1 mm thick film.

TABLE 1

| Number | Symbol | PBAT (g) | MA (g) | Initiator(g) |
|---|---|---|---|---|
| Comparative | Pristine | 30 | 0 | 0 |
| Example 1 | | | | |
| Comparative | ini-Pristine | 30 | 0 | 0.15 |
| Example 2 | | | | |
| Comparative | MA-Pristine | 30 | 1.5 | 0 |
| Example 3 | | | | |
| Example 1 | MA1 | 30 | 0.3 | 0.03 |
| Example 2 | MA3 | 30 | 0.9 | 0.09 |
| Example 3 | MA5 | 30 | 1.5 | 0.15 |
| Example 4 | MA7 | 30 | 2.1 | 0.21 |

### 2. Analysis of Biodegradable Maleated PBAT Hot Melt Adhesives

### <Spectroscopic Analysis>

ATR-FTIR spectra for the above-mentioned manufactured films were performed on a Nicolet iS20 (Thermo Fisher Scientific, Waltham, MA, USA) at room temperature. Measurements were made with 16 scans at a resolution of 4 kaiser, and each spectrum was obtained within the range of 4000-525 kaiser.

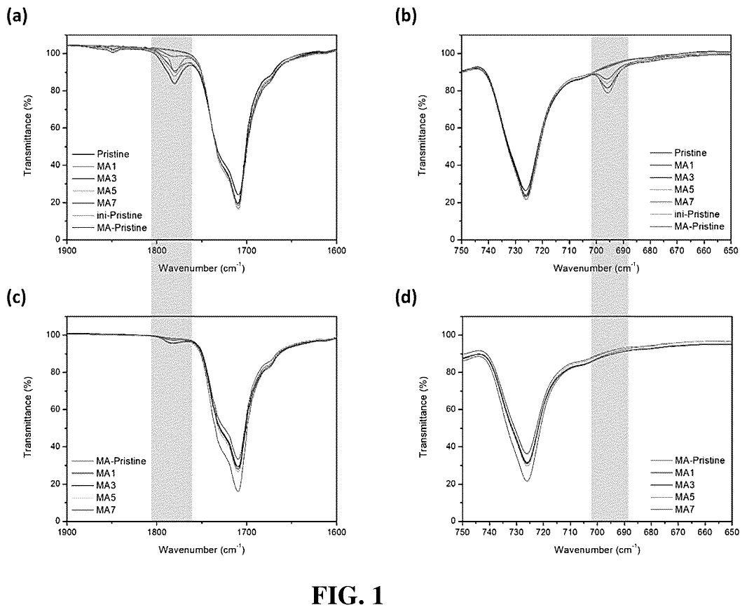

As shown in FIG. 1, peaks at wavelength bands of about 1,762 and 1,835 kaiser were observed in all cases where maleic acid was added. As is well known, this is a peak caused by the symmetric (strong) and asymmetric (weak) C═O stretching vibrations of maleic acid. The peak observed around 675 kaiser is a peak for the C═C bond stretching of maleic acid, and the intensity of the peak increases as the amount of maleic acid added increases.

Among them, it was confirmed that Comparative Example 3 (MA-Pristine) with only maleic acid added showed the highest relative strength (see FIG. 1B). These results are because unreacted maleic acid remains in all films to which maleic acid was added.

Therefore, when the unreacted maleic acid was removed from the film and the ATR-FTIR spectrum was measured, it was confirmed that no peak was observed in the corresponding wavelength band (see FIGS. 1C and 1D). In addition, in the spectrum after removing unreacted maleic acid, the intensity of the peak due to the C═O stretching vibrations of maleic acid decreased, but the intensity order among PBAT grafted with maleic acid was the same as before.

The content of maleic acid grafted onto PBAT was quantified through titration and calculated using the equation below, and the results are shown in Table 2.

$$Grafting rate ( \% ) = ( {W}_{grafted} / {W}_{initial} ) \times 100$$

Consequently, the results of the analysis via IR were consistent with the maleic acid content of maleated PBAT calculated through titration in the same manner as Shao-Jun et al. (ACS Sustainable Chemistry & Engineering 2020 8 (13), 5338-5346).

TABLE 2

| | | MA grafting | Mn | Mw | |
|---|---|---|---|---|---|
| Number | Symbol | rate(%) | (g/mol) | (g/mol) | PDI |
| Comparative | Pristine | 0.00 | 68,325 | 157,520 | 2.31 |
| Example 1 | | | | | |
| Comparative | ini-Pristine | 0.00 | 60,318 | 226,747 | 3.76 |
| Example 2 | | | | | |
| Comparative | MA- | 0.04 | 74,474 | 159,434 | 2.14 |
| Example 3 | Pristine | | | | |
| Example 1 | MA1 | 0.07 | 78,272 | 200,759 | 2.57 |
| Example 2 | MA3 | 0.09 | 75,568 | 213,505 | 2.83 |
| Example 3 | MA5 | 0.15 | 73,092 | 226,804 | 3.10 |
| Example 4 | MA7 | 0.18 | 70,438 | 234,159 | 3.32 |

### <Molecular Weight and Polydispersity Index>

To measure the molecular weights of pure PBAT and maleated PBAT, gel permeation chromatography (GPC) was performed on an Alliance e2695 separation module (Waters, Milford, MA, USA) at 35° C. using standard polystyrene. The residence time was 30 minutes, and chloroform was used as the solvent. The results are shown in Table 2.

GPC analysis results confirm that PBAT reacts with maleic acid and the initiator, resulting in a change in molecular weight. In the case of maleated PBAT, the polydispersity index (PDI) increased as the amount of maleic acid and the initiator reacting with PBAT increased. This is judged to be because, as the reaction progresses, not only grafting of maleic acid but also β-scission of the PBAT chain occurs, and when a polymer chain with a radical site generated by β-scission attacks another polymer chain, branching occurs in the attacked polymer chain.

Therefore, it is judged that the PDI increases as this process is repeated while the reaction is in progress. It was confirmed that the degree of increase in PDI was proportional to the amount of the initiator added. However, the one that showed the highest PDI was Comparative Example 2 (ini-Pristine), which reacted only with the initiator. This is judged to be because the process of grafting maleic acid does not occur during the reaction because maleic acid is not added, so the greatest amount of β-scission can occur during the reaction time. This can also be confirmed through the torque change curve according to reaction time.

### <Rheological Properties>

Dynamic rheological properties were measured using a Discovery HR20 rheometer (TA Instrument, USA) having parallel plates (25 mm, gap 1 mm). For the above measurements, strain sweeps were performed at 160° C., 1 Hz frequency, and a strain rate range of 0.005 to 500 rad/s. Frequency sweeps were performed at 160° C., 1% strain rate, and a frequency range of 0.01 to 628 rad/s. The flow temperature ramp was from 115° C. to 195° C. with a shear rate of 1 s⁻¹ and a ramp rate of 5° C./min.

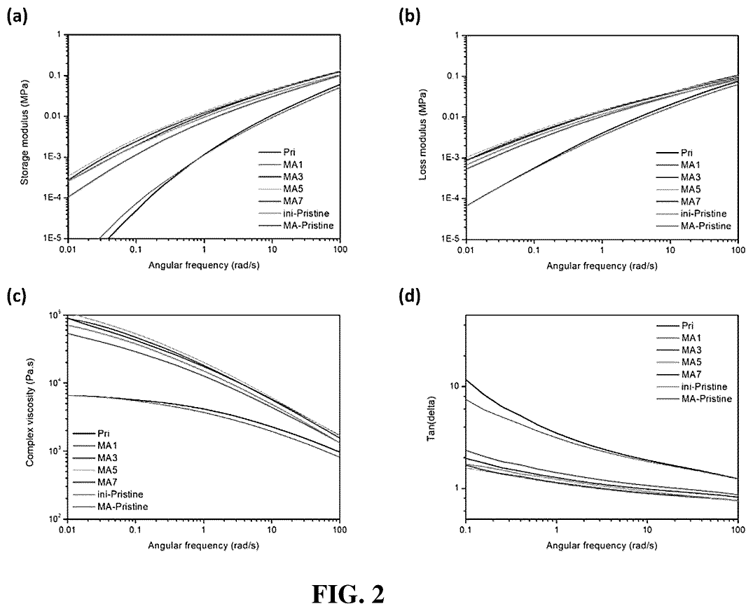

The measurement results are shown in FIG. 2.

As the amount of added maleic acid and the initiator increased compared to pure PBAT (see Comparative Example 1, Pristine), the storage modulus (G′), loss modulus (G″), and complex viscosity (η*) showed increased shear-thinning behavior (see FIGS. 2A, 2B, and 2C). Similarly, it was confirmed that the tan 8 of all maleated PBAT samples showed lower values than PBAT (see FIG. 2D). This phenomenon was observed only in samples to which the initiator was added. Therefore, it can be seen that a structural change in the PBAT chain occurred due to the initiator during the reaction.

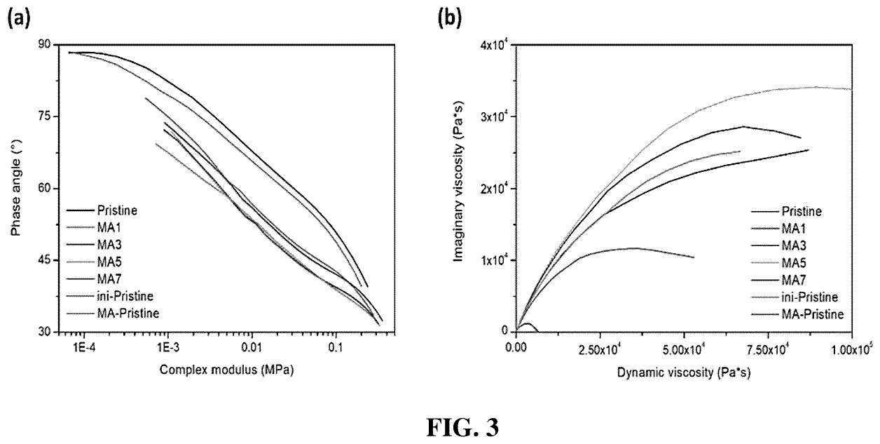

To confirm the structural change of maleated PBAT, the Van Gurp-Palmen plot was checked (see FIG. 3A). In the case of PBAT (Comparative Example 1) and MA-Pristine (Comparative Example 3) without added initiators, a typical linear polymer-like curve was observed. As the phase angle decreases, MA-Pristine (Comparative Example 3) has a lower complex modulus (G*) than Pristine PBAT (Comparative Example 1). This is thought to be due to the effect of unreacted maleic acid.

On the other hand, all samples reacted with the initiator showed curves of different shapes. Unlike linear polymers, the shape of the curve showing a reduced phase angle can be attributed to the complex structure formed by long chain branches (LCBs). This is because a long chain branch structure may be created by β-scission caused by the initiator added during the reaction, which may increase chain entanglement.

To further confirm the influence on the molecular structure, the relationship between the dynamic viscosity (η′) and the imaginary viscosity (η″) was confirmed through the Cole-Cole plot (see FIG. 3B). As a result, the sample without added initiator showed a semicircular curve, which is similar to the behavior of a typical linear polymer. On the other hand, the sample with added initiator shows a curve with an increased radius, which means that the curve with a larger radius has the longest relaxation time. It is also generally known that as molecular weight increases, the radius of the curve increases.

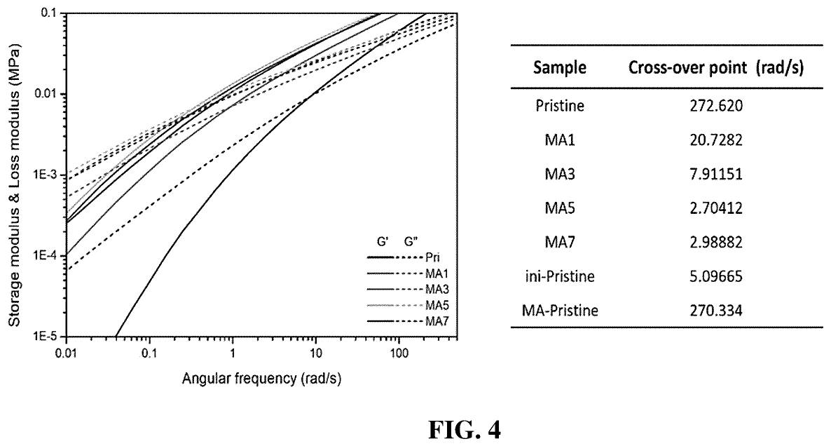

However, when comparing each Mn and Mw in Table 2, MA5 (Example 3) showed the curve with the largest radius even though it did not have the largest Mn and Mw. In addition, when checking the cross-over point of the G′ and G″ curves of each specimen in FIG. 4, it can be confirmed that MA5 (Example 3) shows the cross-over point at the lowest angular frequency.

Looking into the reasons for these results, it can be confirmed that the curve radius size in the Cole-Cole plot, the cross-over point of G′ and G″, and Mw in the GPC results show almost similar trends. However, in the case of Mw only, MA7 has a higher Mw than MA5. As such, the fact that MA5 (Example 3) was confirmed to have the highest molecular weight in the dynamic rheological property analysis results seems to be the result of increased chain entanglement due to the formation of a more complex structure by long chain branches. Previous studies have also reported that the lower the cross-over frequency observed, the longer the relaxation time, which may support the presence of more branched polymers.

The structural influence of these polymer chains was also confirmed in the melt viscosity. As a result of measuring the melt viscosity according to temperature, all maleated PBATs showed higher melt viscosity than Pristine PBAT (Comparative Example 1) in the temperature range above the melting point. Among them, MA5 (Example 3) showed the highest melt viscosity. This is judged to be because the melt viscosity is higher as chain entanglement increases due to long chain branching, as shown in the previous results.

### <Thermal Properties Evaluation>

The thermal stability and unreacted maleic anhydride content for each specimen were measured using a TGA55 thermogravimetric analyzer (TA Instruments, USA) at a temperature of 30 to 600° C., a heating rate of 20° C./min, and a dry nitrogen gas flow rate of 40 mL/min. In addition, the crystallization and melting behaviors were measured using differential scanning calorimetry (DSC). Using DSC25 (TA Instruments), the first heating was performed from room temperature to 180° C. at a rate of 10° C./min, the first cooling was performed from 180° C. to −70° C. at a rate of 10° C./min, and the second heating was performed from −70° C. to 180° C. at a rate of 10° C./min. The isothermal process was maintained for 5 minutes between each step, and all DSC scans were performed under a nitrogen atmosphere.

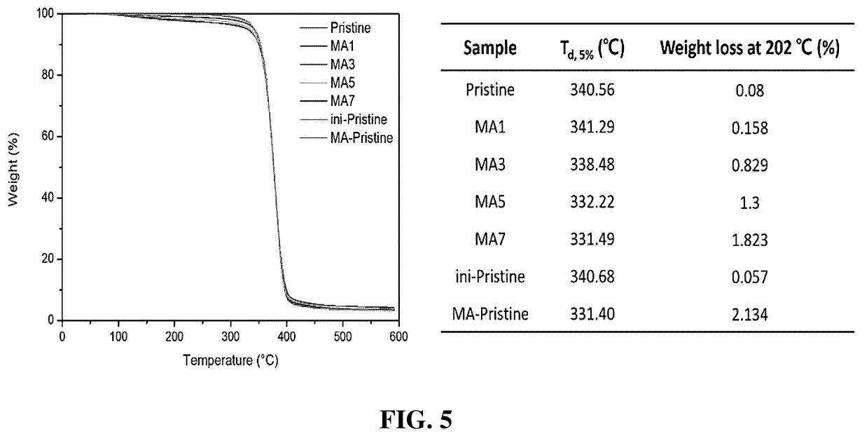

FIG. 5 shows the results of TGA measurements performed under a nitrogen atmosphere. Since only a portion of the maleic acid added during the grafting process participates in the reaction, unreacted maleic acid remains in the maleated PBAT. The weight loss was confirmed for each specimen at 202° C., the boiling point of maleic acid. Pristine PBAT (Comparative Example 1) showed a loss of approximately 0.08%, and maleated PBAT showed a higher weight loss as the amount of the maleic acid and initiator added increased. Among all samples, MA-Pristine (Comparative Example 3) showed the highest weight loss. This is because only a small amount of maleic acid is grafted since no initiator is added, leaving a large amount of unreacted maleic acid, which is also in good agreement with the IR analysis results (see FIG. 1B). For the 5% decomposition temperature, Pristine PBAT showed a 5% decomposition temperature at approximately 340.56° C. On the other hand, maleated PBAT has a 5% decomposition temperature at a lower temperature. The reason for these results is that the weight of residual maleic acid in the total sample weight increased.

The measurement results of crystallization and melting behavior for each specimen are shown in Table 3.

TABLE 3

| | | | | | | Full width at | Crystallization |
|---|---|---|---|---|---|---|---|
| | | Tg | Tc | Tm | Crystallinity | half maximum | initiation |
| Number | Symbol | (° C.) | (° C.) | (° C.) | (%) | of Tc (° C.) | temperature (° C.) |
| Comparative | Pristine | −30.42 | 66.32 | 121.21 | 14.92 | 9.53 | 75.46 |
| Example 1 | | | | | | | |
| Comparative | ini- | −31.31 | 86.68 | 124.43 | 11.51 | 14.9 | 96.06 |
| Example 2 | Pristine | | | | | | |
| Comparative | MA- | −31.40 | 69.45 | 121.13 | 13.81 | 10.55 | 80.6 |
| Example 3 | Pristine | | | | | | |
| Example 1 | MA1 | −29.58 | 66.26 | 119.31 | 14.18 | 10.36 | 75.04 |
| Example 2 | MA3 | −27.85 | 61.24 | 118.76 | 13.97 | 9.76 | 72.89 |
| Example 3 | MA5 | −26.71 | 62.09 | 118.08 | 13.11 | 9.11 | 72.11 |
| Example 4 | MA7 | −24.89 | 64.91 | 117.19 | 13.52 | 9.30 | 73.22 |

The Tg, Tc, and Tm of Pristine PBAT (Comparative Example 1) were −30.42° C., 66.32° C., and 121.2° C., respectively. However, maleated PBAT samples showed different properties. First, looking at the crystallization temperature (Tc), it can be confirmed that maleated PBAT has a lower Tc than Pristine PBAT (Comparative Example 1). This is because chain entanglement increases due to the complex long chain branches (LCBs) structure present in maleated PBAT, which restricts chain movement and makes crystallization more difficult.

Looking at the crystallization onset temperature (Tc, onset), it can be confirmed that maleated PBAT is lower than Pristine PBAT (Comparative Example 1), similar to Tc. However, it is judged that the reason why MA5 (Example 3) has a lower crystallization initiation temperature than MA7 (Example 4) is because there is more chain entanglement in MA5 (Example 3). These effects were confirmed by the fact that the crystallinity calculated through the crystallization peak also showed similar results.

On the other hand, the reason why MA1 (Example 1) shows a slightly higher Tc than Pristine PBAT (Comparative Example 1) is because MA1 has relatively less chain entanglement compared to other maleated PBAT, as can be seen from the dynamic rheological characteristic analysis confirmed above. Therefore, in the case of MA1, since chain entanglement is low, it can be seen that the branched polymer chains generated during the reaction rather assist in crystallization.

All maleated PBATs showed an increase in glass transition temperature (Tg) with increasing the maleic acid and initiator content, despite a decrease in crystallinity. This is because the presence of the LCBs structure and the increase in chain entanglement generated from the structure further restrict the chain movement as it moves through the crystal lattice or other spaces. This confirms that chain entanglement has a more dominant effect than crystallinity in determining Tg.

Similarly, the reason why the Tm of maleated PBAT decreases compared to Pristine PBAT (Comparative Example 1) is because the crystallinity and the perfection degree of crystalline region of maleated PBAT decrease due to the LCBs structure.

MA-Pristine (Comparative Example 3) and ini-Pristine (Example 2) also showed different crystallization and melting behaviors (see Table 3). In the case of MA-Pristine (Comparative Example 3), the crystallinity and Tm decreased, but Tg increased. This can be seen as because unreacted maleic acid acted as a plasticizer, and this effect was also confirmed through the results of dynamic rheological analysis (see FIG. 2). On the other hand, Tc increased compared to Pristine PBAT (Comparative Example 1), which can be seen as the effect of maleic acid acting as a nucleating agent.

In the case of Comparative Example 2 (ini-Pristine), an increased Tc was also observed. This may be because there is little chain entanglement and a large number of chains with a structure that may aid crystallization. In the case of ini-Pristine (Comparative Example 2), it can be confirmed that Tg and Tm are increased compared to Pristine PBAT (Comparative Example 1). This is judged to be because a cross-linking reaction occurred when only peroxide was added to PBAT, resulting in the formation of a small amount of gel within the ini-Pristine (Comparative Example 2) structure.

### 3. Adhesion Evaluation of Maleated PBAT Hot Melt Adhesive

The films manufactured according to Comparative Examples 1 to 3 and Examples 1 to 4 were cut into a rectangular shape (25 mm×12.5 mm). The film was placed between two stainless steel substrates (100 mm×25 mm×1.5 mm) so that the two substrates overlapped each other. At this time, the area where the two substrates overlap is equal to the total area of the film. Thereafter, the film and the two substrates were fixed together with two paper clips and then left in an oven at 130° C. for 20 minutes. The paper clips holding the sample were removed, cooled at room temperature for 24 hours, and then the adhesion was evaluated through a single lap shear test using an ST-1001 electronic universal testing machine. The above evaluation was measured at a tensile speed of 1.3 mm/min, and five specimens were evaluated per specimen and expressed as an average.

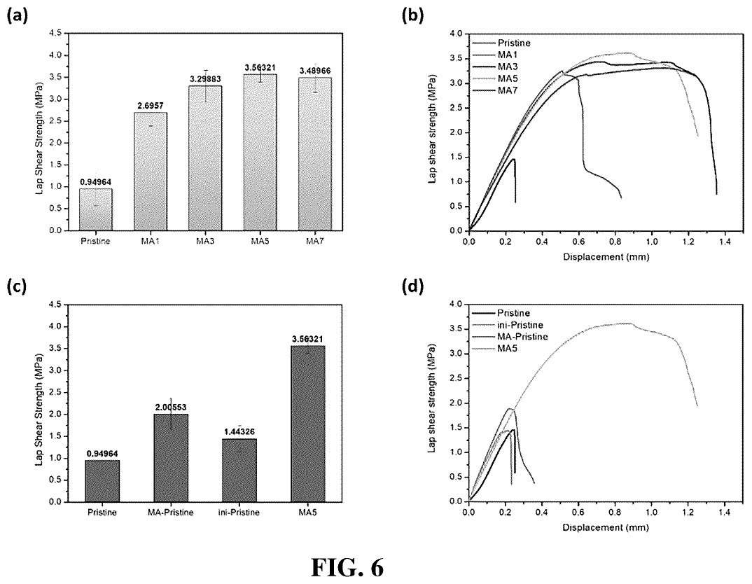

As shown in FIG. 6, the single lap shear test results showed that Pristine PBAT (Comparative Example 1) exhibited an adhesion of 0.95±0.384 MPa (see FIGS. 6A and 6B), and all maleated PBATs exhibited higher adhesion than Pristine PBAT (Comparative Example 1). Among them, the one with the highest value was MA5 (Example 3), which exhibited 3.56±0.174 MPa. MA-Pristine (Comparative Example 3) and ini-Pristine (Comparative Example 2) were 2.01±0.363 and 1.44±0.299 MPa, respectively. Through this, it was confirmed that both specimens had adhesion that was higher than that of Pristine PBAT and lower than that of MA5 (Example 3). The reason for these results is that, firstly, in the case of MA-Pristine (Comparative Example 3), the interaction with the substrate and wettability increased due to the maleic acid grafted to the main chain (see Table 2), so it is judged that it showed improved adhesive strength compared to Pristine PBAT (Comparative Example 1). Previous studies have shown that maleic anhydride can form chemical bonds with substrates having hydroxyl groups.

On the other hand, ini-Pristine (Comparative Example 2) showed higher adhesive strength than Pristine PBAT (Comparative Example 1) even though maleic acid was not present. This is because chains having LCBs that can increase chain entanglement within the ini-Pristine structure can be formed by the initiator. It is judged that an increase in chain entanglement leads to an increase in cohesive energy between chains, which in turn results in improved adhesive strength.

As a result, when only maleic acid is added, as previously confirmed through ATR-FTIR or GPC analysis results, some of the added maleic acid can be grafted onto the PBAT chain, thereby increasing the adhesive strength like maleated PBAT. However, when reacted with an initiator, not only does the amount of grafted maleic acid increase, but it is also judged that the LCBs structure can be formed, resulting in higher adhesive strength. In the case of Example 3 (MA5), it is judged that due to the relatively large amount of maleic acid grafting and at the same time having the most complex LCBs structure among all maleated PBATs, MA5 (Example 3) exhibits similar or higher adhesive strength than MA7 (Example 4) despite not having the highest amount of maleic acid grafted.

### 4. Biodegradability Evaluation of Maleated PBAT Hot Melt Adhesive

Aerobic biodegradation of Pristine PBAT (Comparative Example 1) and maleated PBAT (MA5, Example 3) was evaluated by a controlled composting test according to ISO 14855-1 (2012). The inoculum consisted of stabilized, mature compost derived from the organic fraction of municipal solid waste. The incubation temperature was maintained at 58±2° C., and during aerobic biodegradation of organic material, a gas mixture (mainly carbon dioxide and water vapor) was the final decomposition product, while a portion of the organic material was assimilated for cell growth.

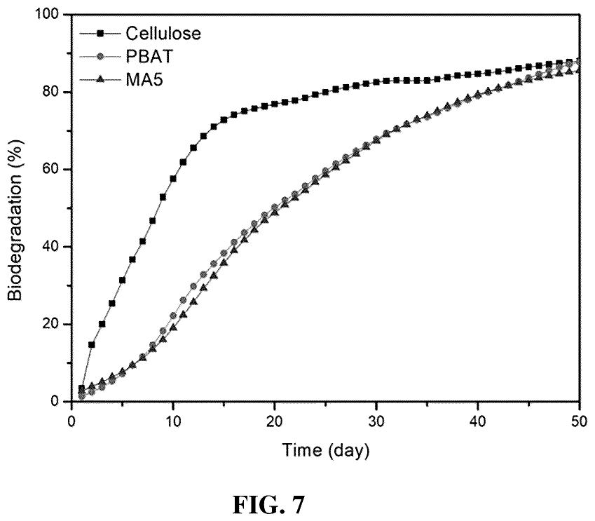

To confirm the biodegradability of biodegradable plastics by hydrolysis and aerobic microorganisms, quantitative analysis of carbon dioxide generated during the biodegradation process was performed, and the results are shown in FIG. 7. According to the guidelines of the ISO 14855-1 test method, the results are valid when the biodegradability of the standard material (cellulose) exceeds 70% for 45 days. In the performed evaluation, the standard material was confirmed to have a biodegradability of 87.98±5.8% for 50 days, so the evaluation result can be considered valid. Pristine PBAT (Comparative Example 1) showed a biodegradability of 87.78±1.8% for 50 days, which corresponds to 99.77% of the biodegradability of the standard material. Maleated PBAT (MA5, Example 3) showed a biodegradability of 85.57±1.7% for 50 days, which corresponds to 97.26% of the biodegradability of the standard material.

Maleated PBAT (Example 3) showed slightly lower biodegradability than Pristine PBAT (Comparative Example 1) due to the LCBs structure formed during the reaction with grafted maleic acid. However, this is judged not to affect the intrinsic biodegradability of PBAT.

Therefore, the biodegradable hot melt adhesive comprising maleated PBAT according to the present invention has improved adhesive strength while maintaining biodegradability almost similar to that of PBAT, and thus may be used as the biodegradable hot melt adhesive.

In addition, although the above-described examples have described biodegradable hot melt adhesive comprising maleated PBAT, the hot melt adhesive comprising maleated PBAT according to the present invention may be prepared as the biodegradable hot melt adhesive comprising a maleated PBAT resin by using one or more additives selected from the group consisting of a tackifier, an adhesion regulator, an antioxidant, a plasticizer, a pigment, and a filler.

As the above-mentioned tackifier, at least one selected from rosin ester-based resins, rosin-based resins, terpene-based resins, petroleum-based resins, and oil-soluble phenol resins may be used, and as the adhesion regulator, the group consisting of valeric acid amide, myristic acid amide, palmitic acid amide, arachidonic acid amide, behenic acid amide, erucic acid amide, stearic acid amide, oleic acid amide, and mixtures thereof may be selected.

By controlling the type and content of the additives, the adhesiveness, thermal stability, color, and mechanical strength of the biodegradable hot melt adhesive comprising maleated PBAT can be controlled.

What is claimed is:

1. A biodegradable hot melt adhesive comprising maleated polybutylene adipate terephthalate (PBAT).

2. The biodegradable hot melt adhesive of claim 1, wherein the maleated PBAT is grafted with 0.07% to 0.18% of maleic acid.

3. The biodegradable hot melt adhesive of claim 2, wherein the maleated PBAT is grafted with 0.12% to 0.16% of maleic acid.

4. The biodegradable hot melt adhesive of claim 1, wherein the biodegradable hot melt adhesive further includes one or more additives selected from the group consisting of a tackifier, an adhesion regulator, an antioxidant, a plasticizer, a pigment, and a filler.

5. A method of preparing a biodegradable hot melt adhesive comprising maleated polybutylene adipate terephthalate (PBAT), the method comprising:
mixing a PBAT resin, maleic acid, and an initiator to prepare a mixture; and
heating and mixing the mixture to grafting maleic acid onto PBAT,
wherein the mixture comprises 1 to 2.1 parts by weight of maleic acid and 0.1 to 0.21 parts by weight of an initiator based on 100 parts by weight of the PBAT resin.

6. The method of claim 5, wherein the heating and mixing the mixture to grafting maleic acid onto PBAT is performed at 185 to 195° C. for 7 to 13 minutes.
